(19) United States
(12) Patent Application Publication
(10) Pub. No.: US 2026/0163823 A1
(43) Pub. Date: Jun. 11, 2026

(54) SECURE NETWORK SLICE ORCHESTRATION BASED ON SLICE RESOURCE ISOLATION REQUIREMENTS

(71) Applicant: Verizon Patent and Licensing Inc., Basking Ridge, NJ (US)

(72) Inventors: Vinod Kumar Choyi, Conshohocken, PA (US); Peter M. Gervase, Holly Springs, NC (US); Michael A. Gallagher, Dublin, OH (US); John M. Bittenbender, Bloomsburg, PA (US)

(21) Appl. No.: 18/976,826

(22) Filed: Dec. 11, 2024

(51) Int. Cl. H04L 41/40; H04L 41/22; H04L 43/08

(52) U.S. Cl. CPC H04L 41/40; H04L 41/22; H04L 43/08

(57) ABSTRACT

A network device receives user-selected performance requirements for a network slice to be implemented in a network and receives user-selected resource isolation requirements for the network slice, where the user selected resource isolation requirements specify a level of isolation to be applied to resources of the network slice in the network. The network device initiates orchestration of the resources of the network slice such that the network slice satisfies the user-selected performance requirements and the resources of the network slice comply with the user-selected resource isolation requirements.

### BACKGROUND

Next Generation mobile networks, such as Fifth Generation New Radio (5G NR) mobile networks, may operate in various frequency ranges, including higher frequency ranges (e.g., in the gigahertz (GHz) frequency band), and may have a broad bandwidth (e.g., near 500-1,000 megahertz (MHz)). The bandwidth of Next Generation mobile networks supports higher speed downloads. The 5G mobile telecommunications standard supports more reliable, massive machine communications (e.g., machine-to-machine (M2M) or Internet of Things (IoT)). Next Generation mobile networks, such as those implementing the 5G mobile telecommunications standard, are expected to enable a higher utilization capacity than current wireless networks, permitting a greater density of wireless users. Next Generation mobile networks are designed to increase data transfer rates, increase spectral efficiency, improve coverage, improve capacity, and reduce latency.

### BRIEF DESCRIPTION OF THE DRAWINGS

FIG. 1 illustrates an exemplary network environment in which the secure enforcement of the isolation of network slice resources may be implemented;

FIG. 2 depicts example components of a Slice Orchestration and Resource Isolation Enforcement System;

FIGS. 3A-3G illustrates various examples of types of slice resource isolation between multiple network slices implemented within a mobile network;

FIG. 3H illustrates a single network slice with slice resource isolation occurring between certain slice resources allocated to two different customers/users;

FIG. 4 is a diagram that depicts exemplary components of a network device;

FIGS. 5-8 depict examples of slice resource orchestration tokens that may be used to specify parameters associated with the particular slice resources, including slice resource isolation;

FIGS. 9A-9C are flow diagrams of an exemplary process for orchestrating a network slice that satisfies slice performance requirements while also enforcing network slice isolation requirements;

FIGS. 10A and 10B illustrate examples of a user interface of a customer/user portal that can be used to supply user-selected slice performance requirements and/or user-selected slice resource isolation requirements for a network slice; and

FIGS. 11A and 11B illustrate examples of operations, messages, and data flows associated with a process.

### DETAILED DESCRIPTION

The following detailed description refers to the accompanying drawings. The same reference numbers in different drawings may identify the same or similar elements. The following detailed description does not limit the invention.

“Network Slicing” is an innovation for implementation in Next Generation Mobile Networks, such as, for example, 5G NR Mobile Networks, and represents a key benefit of Next Generation wireless network architectures. Network slicing is a type of virtualized networking architecture that involves partitioning of a single physical network into multiple virtual networks that include various Virtual Network Functions (VNFs) and/or Cloud-Native Network Functions (CNFs). VNFs include network functions that have been moved out of dedicated hardware devices into software that runs on commodity hardware. VNFs may be executed as one or more Virtual Machines (VMs) on top of the hardware networking infrastructure. CNFs include software implementations of functions that typically execute in a containerized environment.

The partitions or “slices” of a virtualized network, including each network slice's VNFs, CNFs, and other slice resources, may be customized to meet the specific needs of applications, services, devices, customers, or network operators. Each network slice can have its own architecture, provisioning management, and security that supports data sessions transported over the network slice. Bandwidth, capacity, and/or connectivity functions are allocated within each network slice to meet the requirements of the objective of the particular network slice. For example, each network slice, when created in a mobile network, may be designed to satisfy one or more performance characteristics or performance requirements for data sessions that are serviced by the network slice. Network slicing may be implemented in a dynamic fashion, such that the slices of the virtualized network may change over time and may be re-customized to meet new or changing needs of applications, services, devices, customers, or network operators.

Currently, network slices for multiple different customers in Next Generation networks share common slice resources, such as, for example, hardware platforms, compute resources, storage resources, virtualized platforms, transport connections, physical links, and Network Functions (NFs). Typically, there is no isolation of slice resources between different slices that are offered to different network customers, or between different network customers using a same network slice. When a customer requests a new network slice, the network service provider (e.g., Verizon™) typically uses the same slice resources for that customer's network slice as for any other customer. In a circumstance where a customer specifically requests slice resource isolation, an orchestration team may manually configure and make the dedicated resources available for the customer's slice. There is no current mechanism for performing secure slice resource isolation enforcement that ensures that the slice resources that are orchestrated for a particular network slice adhere to isolation requirements of that slice.

Example embodiments described herein implement an automated system for securely orchestrating a network slice while enforcing the isolation of selected resources of the network slice from the slice resources of other network slices and/or enforcing the isolation of selected slice resources between different users/customers in a same network slice or across different network slices. In some implementations, the customer/user may select, via a slice portal, a level, class, or degree of resource isolation among the resources of the customer's/user's network slice relative to other network slices, or among resources allocated to the customer/user relative to other customers/users within a same network slice or across multiple different network slices. In other implementations, the customer/user may select, via the slice portal, particular network slice resources to which resource isolation is to be applied, and may also select a particular level, class, or degree of isolation to be applied to the selected network slice resources. The automated system uses signed resource tokens, issued by a resource authorization server, for securely initiating the orchestration of hardware slice resources and virtualization/application slice resources for each network slice. Example embodiments described herein, thus, enable customer-to-customer isolation of slice resources either between different network slices used by different customers, or within a single network slice used by multiple different customers (i.e., network slice user-to-user isolation).

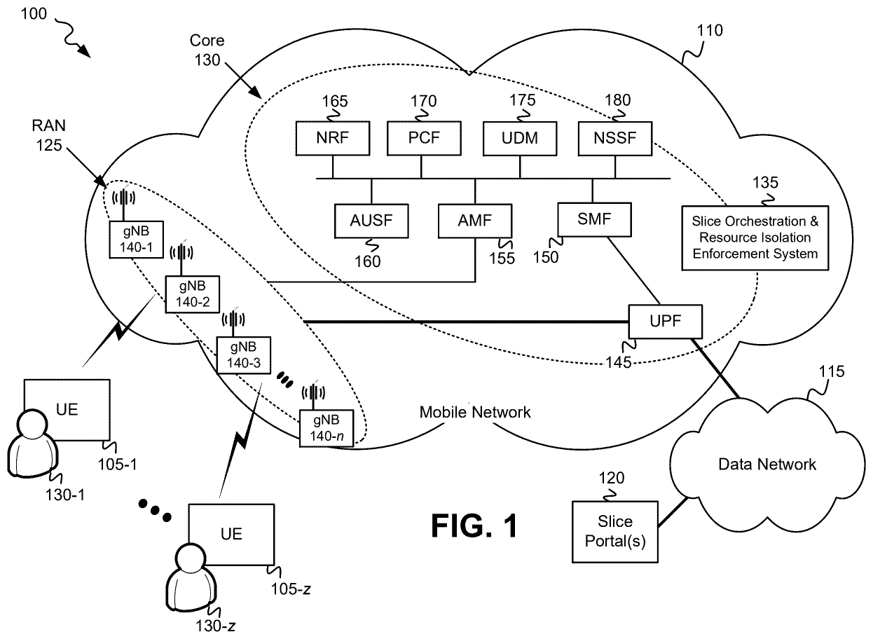

FIG. 1 depicts an exemplary network environment 100 in which the secure enforcement of the isolation of network slice resources may be implemented. As shown, network environment 100 includes User Equipment devices (UEs) 105-1 through 105-z, a mobile network 110, a data network 115, and a slice portal(s) 120. UEs 105-1 through 105-z (referred to herein as “UE 105” or “UEs 105”) may each include any type of electronic device having a wireless communication capability. Though only two UEs 105 are shown, network environment 100 may include numerous UEs (e.g., z>>2). UE 105 may include, for example, a laptop, palmtop, desktop, or tablet computer; a cellular phone (e.g., a “smart” phone); a Voice over Internet Protocol (VoIP) phone; a smart television (TV); an audio speaker (e.g., a “smart” speaker); a video gaming device; a music player (e.g., a digital audio player); a digital camera; a device in a vehicle; a wireless telematics device; an Augmented Reality/Virtual Reality (AR/VR) headset or glasses; or an Internet of Things (IoT) or Machine-to-Machine (M2M) device. A user (also referred to herein as a “subscriber” or a “customer”) may carry, use, administer, and/or operate each UE 105. For example, as shown, a first user 130-1 may operate UE 105-1 and a second user 130-z may operate UE 105-z.

Mobile network 110 (also referred to herein as “wireless network 110” or “network 110”) may include any type of a Public Land Mobile Network (PLMN). In some implementations, mobile network 110 may include any type of a Next Generation mobile network that includes evolved network components (e.g., future generation components) relative to a Long-Term Evolution (LTE) network, such as a Fourth Generation (4G) or 4.5G mobile network. For example, mobile network 110 may include a 5G or a Sixth Generation (6G) mobile network. As shown in FIG. 1, mobile network 110 may include various sub-networks, such as a Radio Access Network (RAN) 125, a mobile core network 130, and possibly other sub-networks not shown. Mobile network 110 may further include a slice orchestration and resource isolation enforcement system 135. In addition to RAN 125 and core network 130, or as components of RAN 125 and/or core network 130, mobile network 110 may further include physical circuits, virtual circuits, physical networks, and virtual networks that extend from the Next Generation NodeBs (gNBs) of RAN 125 to any, or all, NFs, or other network elements, of mobile network 110. Slice resource isolation, as described herein, may also involve the application of transport or data network isolation to the physical circuit(s), virtual circuit(s), physical network(s), and/or virtual network(s), associated with a given network slice, that extend between a gNB(s) and one or more NFs and/or other network elements which service traffic for the given network slice. A “network slice,” as referred to herein may, thus, include any physical circuit(s), virtual circuit(s), physical network(s), virtual network(s), NF(s), or other network elements involved in serving traffic for that network slice.

RAN 125 may include various types of radio access equipment that enable Radio Frequency (RF) communication with UEs 105. The radio access equipment of RAN 125 may include, for example, multiple Next Generation NodeBs (gNBs) 140-1 through 140-n (also referred to as “base stations”). In implementations in which a gNB 140 includes distributed components, the gNB 140 may include a Centralized Unit (CU) (not shown), multiple Distributed Units (DUs) (not shown), and multiple Radio Units (RUs)(not shown).

Each CU of a gNB 140 includes a network device that operates as a digital function unit that transmits digital baseband signals to the multiple DUs of the gNB 140, and receives digital baseband signals from the multiple DUs of the gNB 140. The DUs perform centralized processing and coordination of multiple RUs of the gNB 140, handles tasks such as scheduling and overall control of the radio resources, and interfaces with the core NFs to establish and manage connections with UEs 105 and to facilitate communication between different cells. The RUs of a gNB 140 may include network devices, that may be located at fixed geographic positions within mobile network 110, and operate as radio function units that transmit and receive RF signals to/from UEs 105. Each CU of a gNB 140 may interconnect with the DUs of the gNB 140 via fronthaul links or a fronthaul network. Each of the RUs may include at least one antenna array, transceiver circuitry, and other hardware and software components for enabling the DUs to receive data via wireless RF signals from UEs 105, and to transmit wireless RF signals to UEs 105. Each RU of a gNB 140 further connects to a respective DU of the gNB 140 that may serve as a coordinator for multiple RUs. In other implementations, one or more of the gNBs 140 of RAN 125 may instead be an evolved NodeB (eNB), which may also be referred to herein as a “base station.” RAN 125 may additionally include other nodes, functions, and/or components not shown in FIG. 1.

Core network 130 includes devices or nodes that host and execute network functions (NFs) that operate the mobile network 110 including, among other NFs, mobile network access management, session management, and policy control NFs. In the example network environment 100 of FIG. 1, core network 130 is shown as including 5G NFs, such as a User Plane Function (UPF) 145, a Session Management Function (SMF) 150, an Access and Mobility Management Function (AMF) 155, an Authentication Service Function (AUSF) 160, a Network Repository Function (NRF) 165, a Policy Control Function (PCF) 170, a Unified Data Management (UDM) function 175, and a Network Slice Selection Function (NSSF) 180. UPF 145, SMF 150, AMF 155, AUSF 160, NRF 165, PCF 170, UDM 175, and NSSF 180 may be implemented as VNFs or CNFs (e.g., at a data center(s) within mobile network 110). Core network 130 is further shown as including slice orchestration and resource isolation enforcement system 135. In other implementations, system 135 may be located within mobile network 110, but outside of core network 130, or may be located in an external network (e.g., a Multi-Access Edge Computing (MEC) network) connected to mobile network 110.

UPF 145 may act as a router and a gateway between mobile network 110 and data network 115, and forwards session data between data network 115 and RAN 125. Though only a single UPF 145 is shown in FIG. 1, mobile network 110 may include multiple UPFs 145 at various locations in mobile network 110. SMF 150 performs session management and selects and controls UPFs 145 for data transfer. AMF 155 performs mobility management for the UEs 105.

AUSF 160 may implement authentication and security key management functions for authorizing UE access to mobile network 110 and for establishing secure connections. AUSF 160 further interacts with AMF 155 to manage subscriber mobility and handover procedures, supports session management, and interacts with UDM 175 to manage subscriber data and profiles.

NRF 165 operates as a centralized repository of information regarding NFs in mobile network 110. NRF 165 enables NFs (e.g., UPF 145, SMF 150, AMF 155, PCF 170, UDM 175, NSSF 180) to register and discover each other via an Application Programming interface (API). NRF 165 maintains an updated repository of information about the NFs available in mobile network 110, along with information about the services provided by each of the NFs. NRF 165 further enables the NFs to obtain updated status information of other NFs in mobile network 110. NRF 165 may, for example, maintain profiles of available NF instances and their supported services, allow NF instances to discover other NF instances in mobile network 110, and allow NF instances to track the status of other NF instances.

PCF 170 may provide policy rules for control plane functions (e.g., for network slicing, roaming, and/or mobility management) and may access user subscription information for policy decisions. UDM 175 manages data for user access authorization, user registration, and data network profiles. UDM 175 may include, or operate in conjunction with, a User Data Repository (UDR—not shown) which stores user data, such as customer profile information, customer authentication information, user-subscribed network slice information, and encryption keys. NSSF 180 may obtain Network Slice Instance (NSI) and network slicing configuration information from Slice Orchestration and Resource Isolation Enforcement System 135 and may select a set of network slice instances that may serve a UE session and may determine an allowed single Network Slice Selection Assistance Information (S-NSSAI) for the UE session.

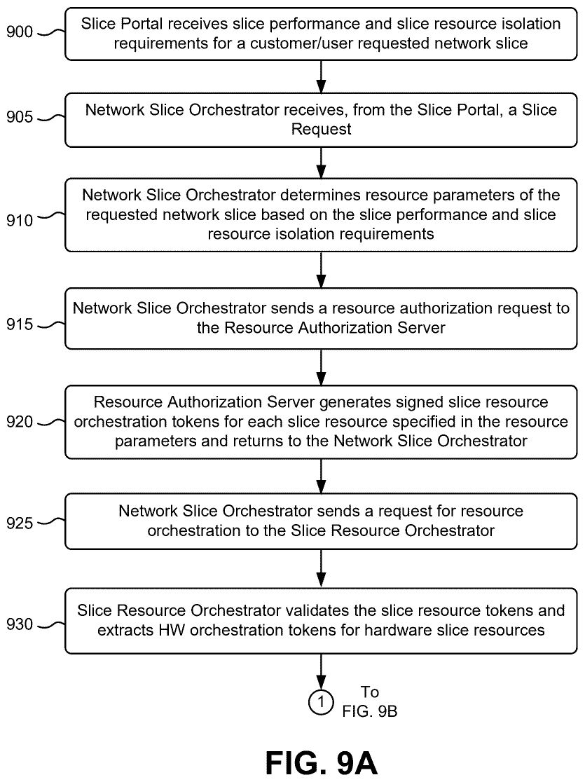

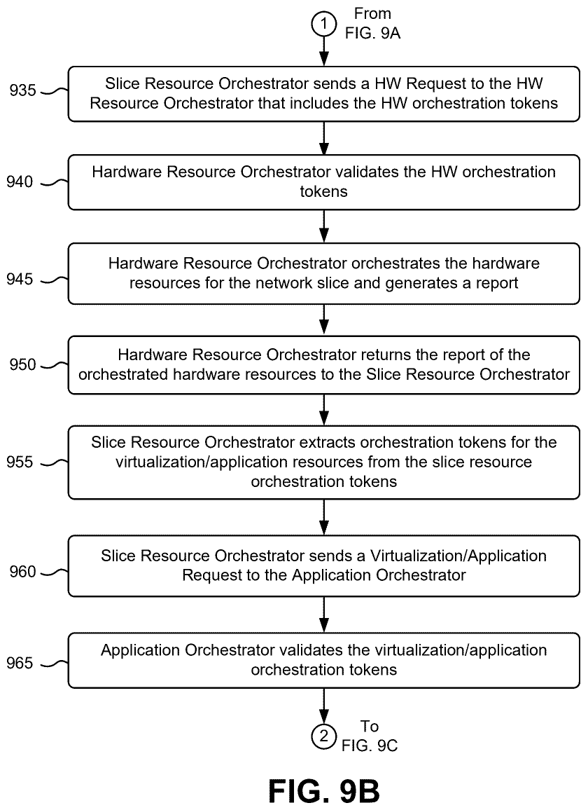

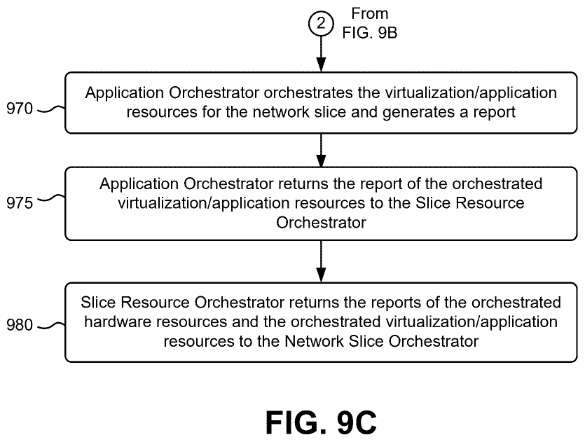

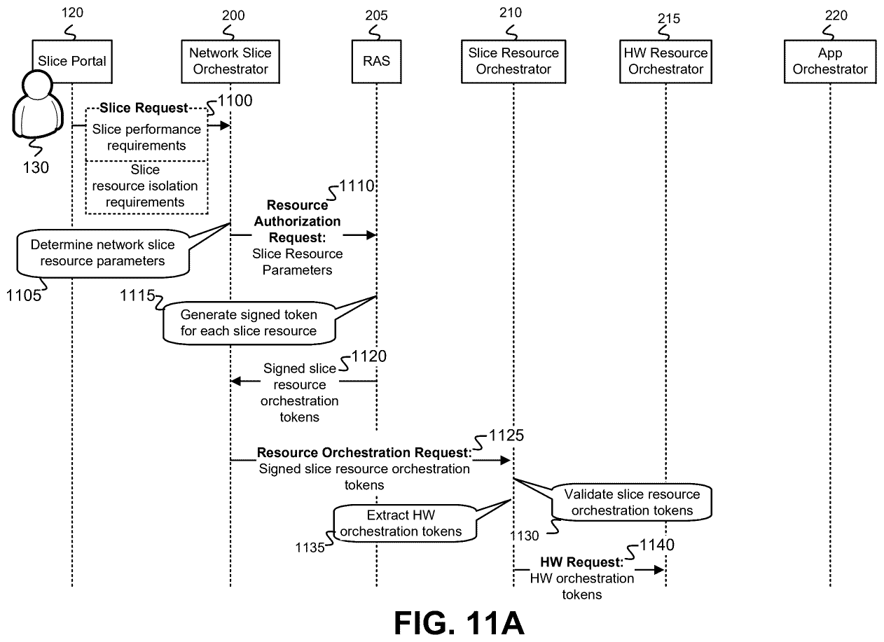

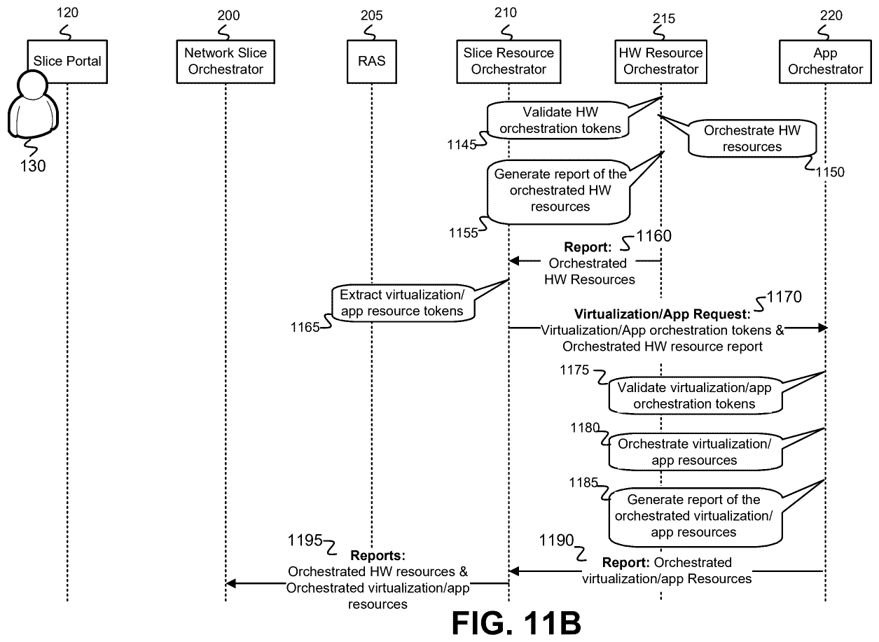

Slice Orchestration and Resource Isolation Enforcement System 135 may implement network slices within mobile network 110 to comply with particular customer/user-specified network slice performance requirements and/or particular customer/user-specified resource isolation requirements, as described further herein. Slice Orchestration and Resource Isolation Enforcement System 135 may perform, among other operations and functions, mobile network slice and NSI creation, virtual and physical network resource allocation, instantiation, and provisioning, and mobile network slice and NSI monitoring, reporting, and life cycle management (LCM). Example operations performed by Slice Orchestration and Resource Isolation Enforcement System 135 are described below with respect to FIGS. 9A-9C and 11A and 11B .

Data network 115 may include one or more interconnected networks, such as local area networks (LANs), wide area networks (WANs), metropolitan area networks (MANs), Public Switched Telephone Networks (PSTNs), MECs, and/or the Internet. Data network 115 may, for example, connect with UPFs 145 of mobile network 110.

Slice Portal 120 may implement a user interface (UI) that enables a user or customer to set up, establish, and orchestrate, in an automated manner, a user-specified network slice that satisfies user-customized network performance requirements and user-customized slice resource isolation requirements. In one embodiment, slice portal 120 may provide a graphical UI (GUI) that a user/customer may use to select particular network performance requirements and particular slice resource isolation requirements, as described further below. In one implementation, slice portal 120 may be implemented by software that is installed upon a device (e.g., a computer or UE 105) that connects to data network 115 (e.g., via a wired network, or wirelessly via mobile network 110). A single slice portal 120 is shown in FIG. 1, however, multiple slice portals 120 may connect to mobile network 110 either directly, or via data network 115. In one implementation, one or more of UEs 105-1 through 105-z may implement a slice portal 120 to enable a respective user/customer 130 to establish a network slice in mobile network 110 and select and customize network performance requirements and slice resource isolation requirements for the user's/customer's network slice.

The configuration of network components of the example mobile network 110 of FIG. 1 is for illustrative purposes. Other configurations may be implemented. Therefore, mobile network 110 may include additional, fewer, and/or different components that may be configured in a different arrangement than that depicted in FIG. 1. For example, core network 130 may include other NFs not shown in FIG. 1. As a further example, though mobile network 110 is depicted in FIG. 1 as a 5G network having 5G network components/functions, mobile network 110 may alternatively include a 4G or 4.5G network with corresponding network components/functions, or a hybrid 5G/4G network that includes certain components of both a Next Generation network (e.g., a 5G network) and a 4G Long Term Evolution (LTE) network. Mobile network 110 may alternatively include another type of Next Generation network, other than the 5G network shown in FIG. 1 (e.g., a Sixth Generation (6G) mobile network).

Additionally, though only a single instance of each of the NFs (e.g., UPF 145, SMF 150, AMF 155, AUSF 160, NRF 165, PCF 170, UDM 175, NSSF 180) is shown in FIG. 1, mobile network 110 may include multiple instances of each of the NFs. For example, when Slice Orchestration and Resource Isolation Enforcement System 135 implements network slicing, each of the configured network slices may include one or more of its own dedicated NFs (e.g., SMF 150, PCF 170, UPF 145), or other dedicated virtual or physical network slice resources (e.g., physical links, hardware platforms, compute, storage, data centers). Each of the NFs described above may be installed in, and be executed by, a network device residing in mobile network 110, or in another network (e.g., in an edge or a far edge network, not shown). A single network device may host and execute one or more of the NFs described above, and mobile network 110 may include at least one network device, or may have multiple (e.g., numerous) network devices that each host and execute one or more of the NFs described above.

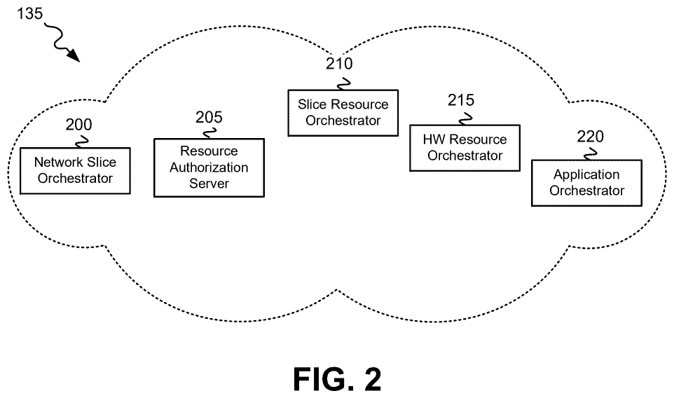

FIG. 2 depicts example components of Slice Orchestration and Resource Isolation Enforcement System 135. In the example shown, system 135 includes multiple networked components, including a Network Slice Orchestrator 200, a Resource Authorization Server (RAS) 205, a Slice Resource Orchestrator 210, a Hardware (HW) Resource Orchestrator 215, and an Application Orchestrator 220. The components of system 135 may communicate with another via, for example, network connections (not shown) that may also interconnect with one or more other components of mobile network 110.

Network Slice Orchestrator 200 receives slice performance and slice resource isolation requirements for a customer's/user's requested or identified network slice (e.g., from slice portal 120) and determines parameters of the resources, including hardware, software, and virtualized resources, that may be used to operate the requested network slice while satisfying the slice performance requirements and enforcing the slice resource isolation requirements. Network Slice Orchestrator 200 interacts with Resource Authorization Server 205 to obtain signed slice resource tokens that may be used to request slice hardware orchestration from HW Resource Orchestrator 215 and to request application/virtualization orchestration from application orchestrator 220.

Resource Authorization Server (RAS) 205 generates signed slice resource tokens for each network slice resource from the network slice resource parameters determined by Network Slice Orchestrator 200. RAS 205 returns the signed slice resource tokens to Network Slice Orchestrator 200 for use in requesting hardware, software, and virtualized resources from Orchestrators 215 and 220.

Slice Resource Orchestrator 210 validates slice resource tokens received in Resource Orchestration Requests from Network Slice Orchestrator 200 and coordinates the orchestration of hardware, software, and virtualized resources by Orchestrators 215 and 220. HW Resource Orchestrator 215 validates slice resource orchestration tokens (e.g., HW orchestration tokens) received in Requests from Slice Resource Orchestrator 210 and orchestrates network slice hardware resources in accordance with the content of the slice resource orchestration tokens. Application Orchestrator 220 validates slice resource orchestration tokens (e.g., virtualization/application orchestration tokens) received in Requests from Slice Resource Orchestrator 210 and orchestrates network slice virtualized and/or application resources in accordance with the content of the slice resource orchestration tokens. Validation of the slice resource tokens by HW Resource Orchestrator 215 and Application Orchestrator 220 may include checking the freshness and/or ensuring the authenticity of the tokens by checking the digital signature in the token against the public key/certificate associated with the RAS 205. The public key/certificate associated with the RAS 205 may have been pre-provisioned to HW Resource Orchestrator 215 and Application Orchestrator 220.

The Slice Orchestration & Resource Isolation Enforcement System 135 of FIG. 1 may be implemented by one or more network devices, each of which of may be interconnected with at least one other component of system 135, and system 135 further interconnects with one or more other components of mobile network 110. In one implementation, each component (e.g., 200, 205, 210, 215, and 220) may be implemented by at least one separate network device. In other implementations, multiple components of system 135 may be implemented by a same network device. As one example, the functions/operations performed by Network Slice Orchestrator 200 and Slice Resource Orchestrator 210 may be implemented by a same network device, and the functions/operations performed by HW Resource Orchestrator 215 and Application Orchestrator 220 may also be implemented by a same network device. System 135 may, in some implementations, include additional, fewer, or different components than those shown in FIG. 1.

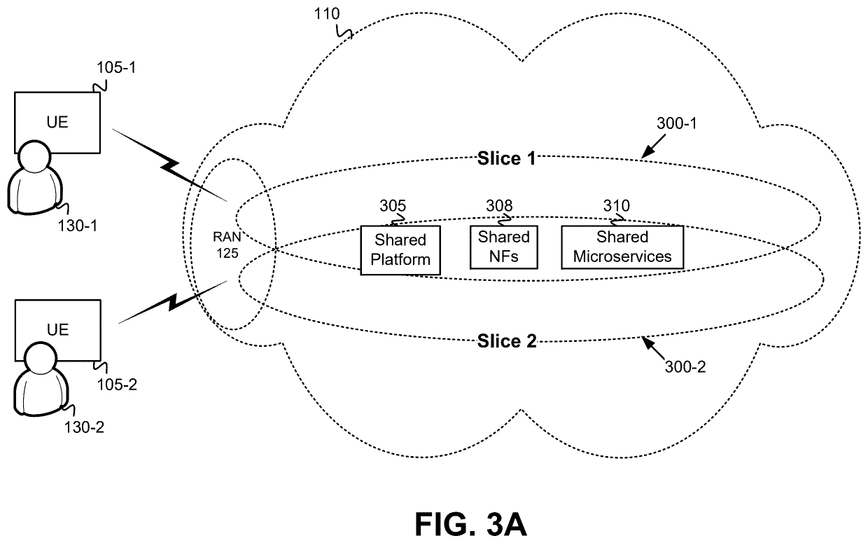

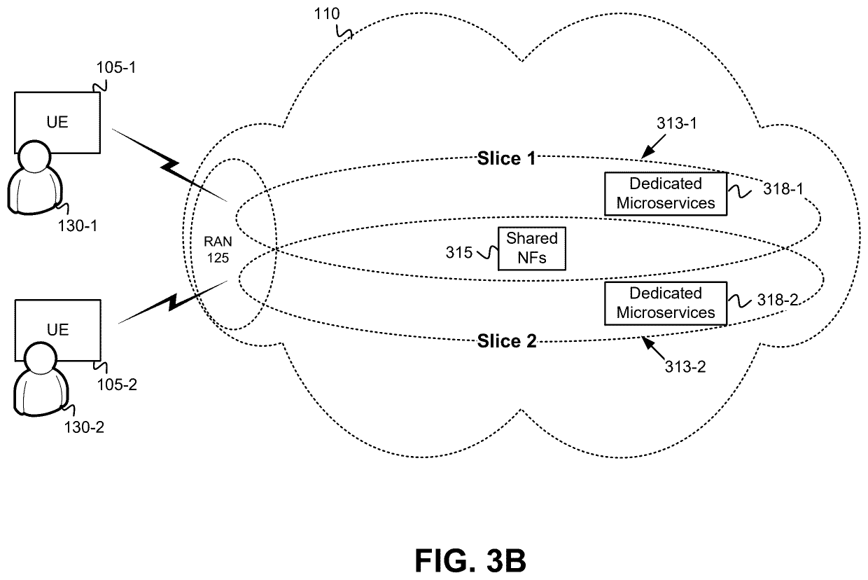

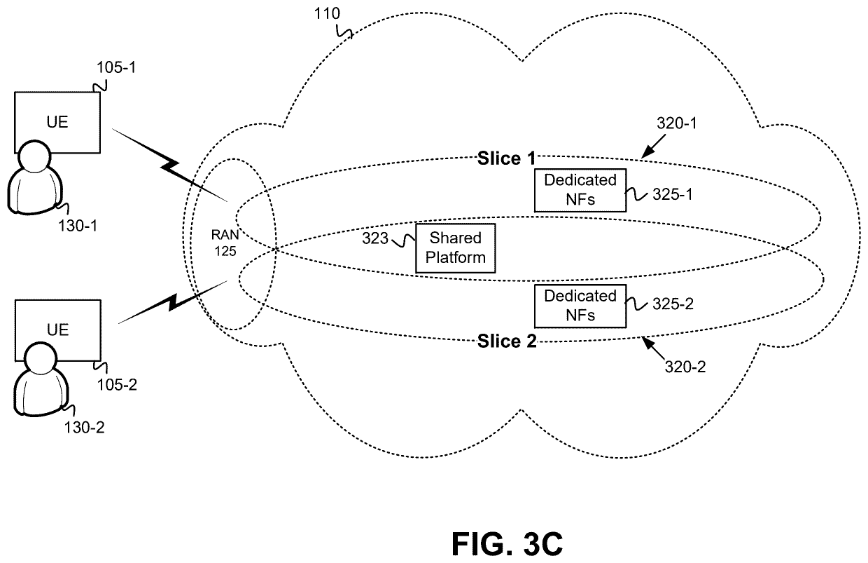

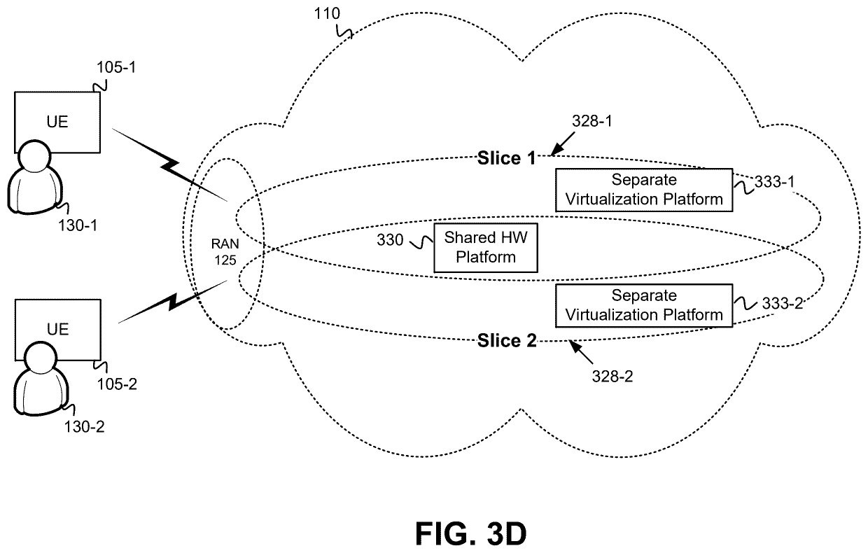

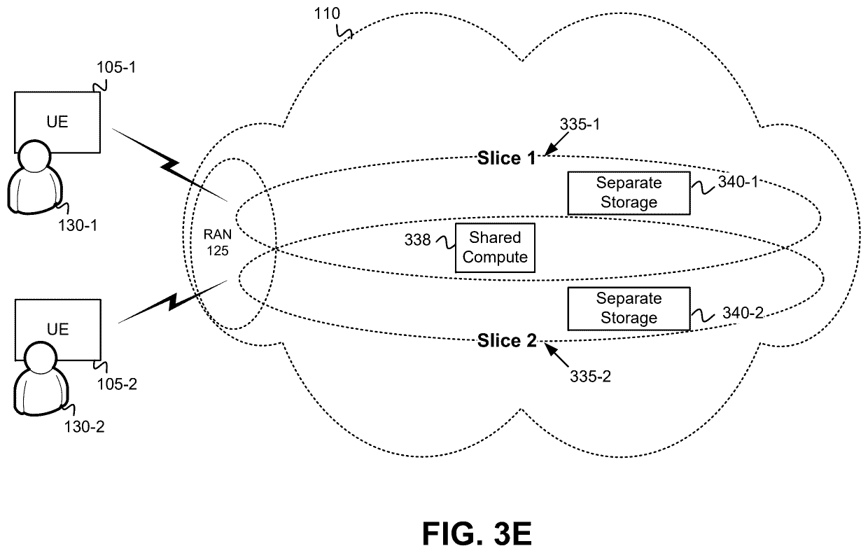

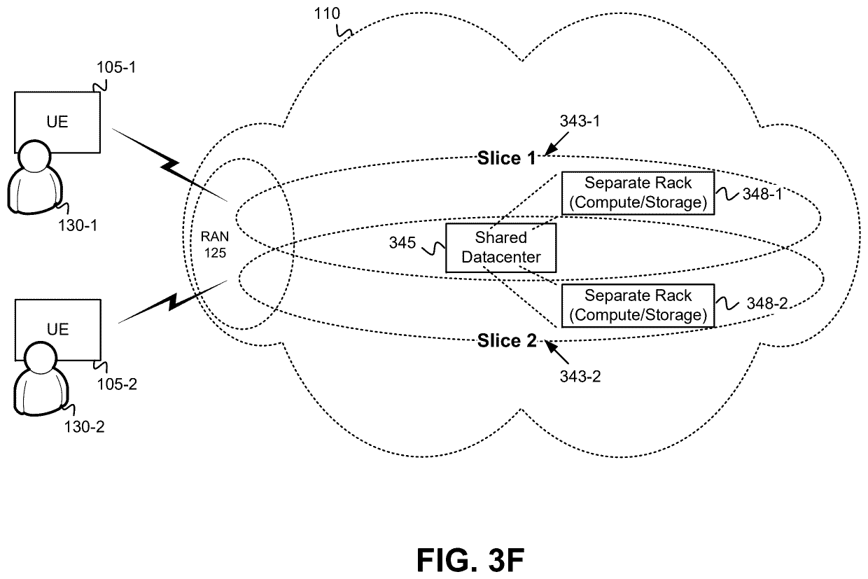

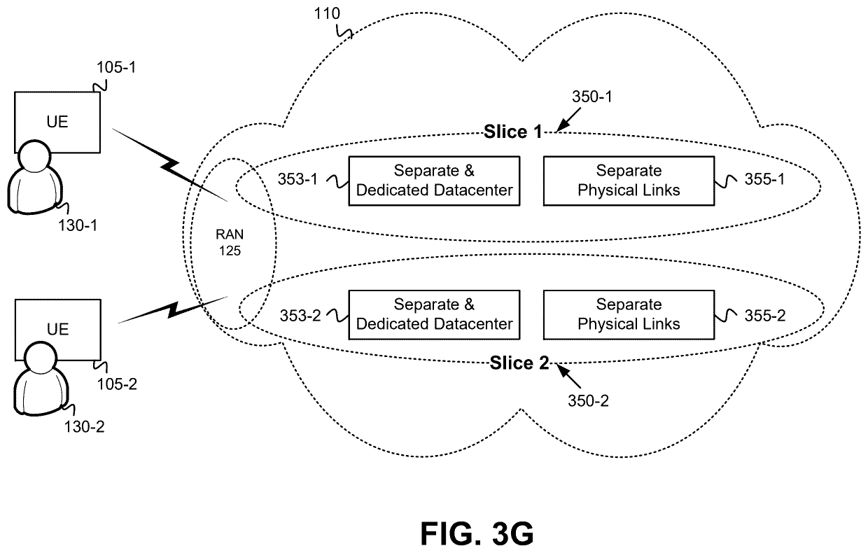

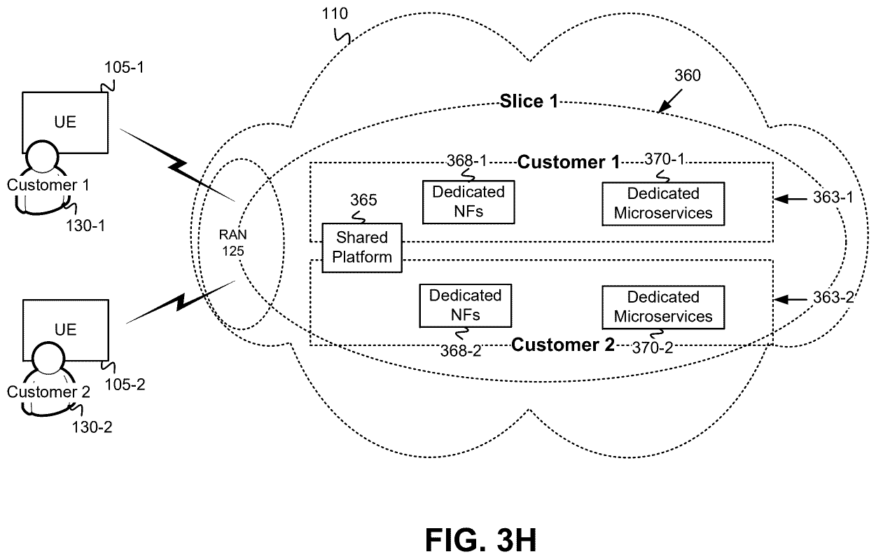

FIGS. 3A-3G illustrates various examples of types of slice resource isolation between multiple network slices implemented within mobile network 110 or between multiple customers/users within a same network slice or across multiple network slices. The resource isolation implemented within each network slice may, in some implementations, be specified by the network slice's customer(s)/user(s) 130, as described further herein. FIGS. 3A-3G each show two example network slices, however, numerous (>>2) network slices may be implemented within mobile network 110. FIG. 3H illustrates a single network slice with slice resource isolation occurring between certain slice resources allocated to two different customers/users. In addition to satisfying customer-selected resource isolation requirements, each network slice of the network slices of mobile network 110 shown in FIGS. 3A-3H may service a particular service type and/or may satisfy or meet particular performance characteristics or parameters for customer/user sessions served by the network slice.

FIG. 3A shows a first network slice 300-1 associated with a first customer/user 130-1 and a second network slice 300-2 associated with a second customer/user 130-2. In this example, both customer/user 130-1 and customer/user 130-2 have specified network slice resource isolation requirements (e.g., via slice portal 120—not shown) which include that their respective network slices may share a common platform, common NFs, and common microservices with at least one other network slice. Thus, as shown in FIG. 3A, network slice 300-1 shares a platform 305, NFs 308, and microservices 310 with network slice 300-2. The shared platform 305 may include a hardware platform and/or a virtualization platform.

FIG. 3B shows a first network slice 313-1 associated with a first customer/user 130-1 and a second network slice 3131-2 associated with a second customer/user 130-2. In this example, both customer/user 130-1 and customer/user 130-2 have specified network slice resource isolation requirements which include that their respective network slices may share common NFs, but have their own dedicated microservices. Therefore, as shown in FIG. 3B, network slice 313-1 shares common NFs 315 with network slice 313-2, but network slice 313-1 has its own dedicated microservices 318-1 and network slice 313-2 has its own dedicated microservices 318-2. Each microservice of microservices 318-1 and 318-2 may be part of a distributed microservices architecture in which an application may be composed into separate components or services for execution by distributed computers. In a distributed microservices architecture, each application is divided into distinct tasks and services, and each task or service is created independently and is executed as a distinct microservice.

FIG. 3C shows a first network slice 320-1 associated with a first customer/user 130-1 and a second network slice 320-2 associated with a second customer/user 130-2. In this example, both customer/user 130-1 and customer/user 130-2 have specified network slice resource isolation requirements which include that their respective network slices may share a common platform, but each of network slices 320-1 and 320-2 are to have their own dedicated NFs. Therefore, as shown in FIG. 3C, network slice 320-1 shares a common platform 323 with network slice 320-2, but network slice 320-1 has its own dedicated NFs 325-1 and network slice 320-2 has its own dedicated NFs 325-2. The shared platform 323 may include a hardware platform and/or a virtualization platform.

FIG. 3D shows a first network slice 328-1 associated with a first customer/user 130-1 and a second network slice 328-2 associated with a second customer/user 130-2. In this example, both customer/user 130-1 and customer/user 130-2 have specified network slice resource isolation requirements which include that their respective network slices may share a common hardware platform, but each of network slices 328-1 and 328-2 are to have their own separate virtualization platforms. Thus, as shown in FIG. 3D, network slice 328-1 shares a common hardware platform 330 with network slice 328-2, but network slice 328-1 has its own separate virtualization platform 333-1 and network slice 328-2 has its own separate virtualization platform 333-2.

FIG. 3E shows a first network slice 3335-1 associated with a first customer/user 130-1 and a second network slice 3335-2 associated with a second customer/user 130-2. In this example, both customer/user 130-1 and customer/user 130-2 have specified network slice resource isolation requirements which include that their respective network slices may share compute resources, but have their own separate storage. Therefore, as shown in FIG. 3E, network slice 335-1 shares compute resources 338 with network slice 335-2, but has its own separate storage resources 340-1 and network slice 335-2 has its own separate storage resources 340-2.

FIG. 3F shows a first network slice 343-1 associated with a first customer/user 130-1 and a second network slice 343-2 associated with a second customer/user 130-2. In this example, both customer/user 130-1 and customer/user 130-2 have specified network slice resource isolation requirements which include that their respective network slices may share a datacenter with one or more other network slices, but have their own dedicated, separate racks within the datacenter. Each rack may further have its own dedicated and separate compute and storage resources. Thus, as shown in FIG. 3F, network slice 343-1 shares a datacenter 345 with network slice 343-2, but has its own separate, dedicated rack 348-1 in the datacenter 345 while network slice 343-2 also has its own separate, dedicated rack 348-2 in the datacenter 345.

FIG. 3G shows a first network slice 350-1 associated with a first customer/user 130-1 and a second network slice 350-2 associated with a second customer/user 130-2. In this example, both customer/user 130-1 and customer/user 130-2 have specified network slice resource isolation requirements which include that their respective network slices have separate and dedicated datacenters and separate physical links. Therefore, FIG. 3G shows network slice 350-1 as having its own separate, dedicated datacenter 353-1 and separate physical links 355-1, and network slice 350-2 also having its own separate, dedicated datacenter 353-2 and separate physical links 355-2.

FIG. 3H shows an example of a single network slice 360 that is partially shared between a first customer 130-1 and a second customer 130-2, with certain slice resources of the network slice 360 being isolated between the customers 130-1 and 130-2. In this example, both customer/user 130-1 and customer/user 130-2 have specified network slice resource isolation requirements which include that, though they share an overall network slice, certain designated slice resources 363-1 and 363-2 are isolated between the customer/users 130-1 and 130-2 within the network slice 360. In the particular example shown in FIG. 3H, customer 130-1 and customer 130-2 share a platform 365 within network slice 360, but customer 130-1 has their own dedicated NFs 368-1 and dedicated microservices 370-1 and customer 130-2 has their own dedicated NFs 368-2 and dedicated microservices 370-3 within network slice 360. Different slice resources, than those shown in FIG. 3H, may be isolated and segregated between different customers/users within a same network slice, with each customer/user selecting and customizing the slice resources that are to be shared, and to be isolated, within the network slice.

Each of the network slices shown in FIGS. 3A-3H is served by its own NSI(s). A NSI includes a set of NF instances, and other hardware resources (e.g., hardware platform, compute, storage, and/or networking resources) and virtualized resources, required to form a deployed NSI. Thus, each network slice may include one or more NSIs. Each NSI may serve the overall purpose and/or performance requirements of the network slice, while at the same time meeting the slice's slice resource isolation requirements. Each NSI may be assigned its own unique NSI identifier (ID). In some implementations, each network slice may have its own Slice/Service Type (SST), such as, for example, an enhanced Mobile Broadband (eMBB) SST, an Ultra Reliable Low Latency Communications (URLLC) SST, or a Massive Internet of Things (MIoT) SST. Each network slice may, however, have a different SST not described herein.

Each of the network slices shown in FIGS. 3A-3H may further be assigned a S-NSSAI value that uniquely identifies the network slice. The S-NSSAI value may include a SST value and a Slice Differentiator (SD) value (e.g., S-NSSAI=SST+SD). The SST may define the expected behavior of the network slice in terms of specific features and services. The SD value may be directly related to the SST value and may be used as an additional differentiator (e.g., if multiple network slices carry the same SST value). The S-NSSAI may be used within mobile network 110 for network slice selection for servicing UE sessions.

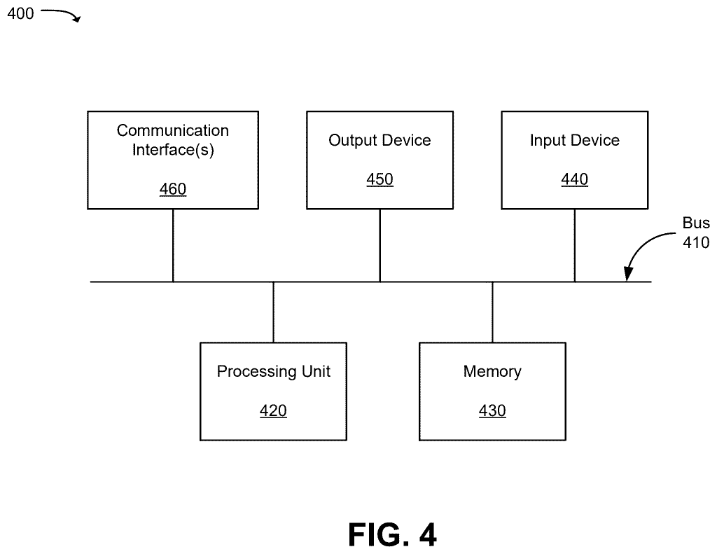

FIG. 4 is a diagram that depicts exemplary components of a network device 400 (referred to herein as a “network device” or a “device”). UEs 105, the CUs, RUs, and DUs of RAN 125, Network Slice Orchestrator 200, Resource Authorization Server 205, Slice Resource Orchestrator 210, HW Resource Orchestrator 215, and Application Orchestrator 220 may include components that are the same as, or similar to, those of device 400 shown in FIG. 4. Furthermore, each of the network functions UPF 145, SMF 150, AMF 155, AUSF 160, NRF 165, PCF 170, UDM 175, and NSSF 180 may be implemented by a network device that includes components that are the same as, or similar to, those of device 400. Some of the NFs UPF 145, SMF 150, AMF 155, AUSF 160, NRF 165, PCF 170, UDM 175, and NSSF 180 may be implemented by a same device 400 within mobile network 110, while others of the functions may be implemented by one or more separate devices 400 within mobile network 110.

Device 400 may include a bus 410, a processing unit 420, a memory 430, an input device 440, an output device 450, and a communication interface 460. Bus 410 may include a path that permits communication among the components of device 400. Processing unit 420 may include one or more processors or microprocessors which may interpret and execute instructions, or processing logic. Memory 430 may include one or more memory devices for storing data and instructions. Memory 430 may include a random access memory (RAM) or another type of dynamic storage device that may store information and instructions for execution by processing unit 420, a Read Only Memory (ROM) device or another type of static storage device that may store static information and instructions for use by processing unit 420, and/or a magnetic, optical, or flash memory recording and storage medium. The memory devices of memory 430 may each be referred to herein as a “tangible non-transitory computer-readable medium,” “non-transitory computer-readable medium,” or “non-transitory storage medium.” In some implementations, the processes/methods set forth herein can be implemented as instructions that are stored in memory 430 for execution by processing unit 420.

Input device 440 may include one or more mechanisms that permit an operator to input information into device 400, such as, for example, a keypad or a keyboard, a display with a touch sensitive panel, voice recognition and/or biometric mechanisms, etc. Output device 450 may include one or more mechanisms that output information to the operator, including a display, a speaker, etc. Input device 440 and output device 450 may, in some implementations, be implemented as a user interface (UI) that displays UI information and which receives user input via the UI. Communication interface 460 may include a transceiver(s) that enables device 400 to communicate with other devices and/or systems. For example, communication interface 460 may include one or more wired and/or wireless transceivers for communicating via mobile network 110 and/or data network 115. In the case of RUs of RAN 125, communication interface 460 may further include one or more antenna arrays for producing radio frequency (RF) cell sectors.

The configuration of components of network device 400 illustrated in FIG. 4 is for illustrative purposes. Other configurations may be implemented. Therefore, network device 400 may include additional, fewer and/or different components, that may be arranged in a different configuration, than depicted in FIG. 4.

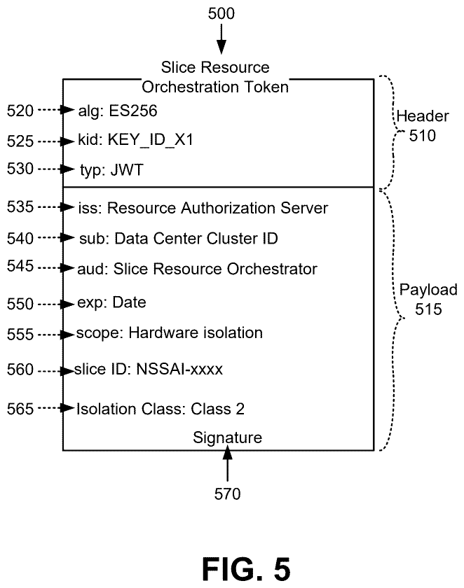

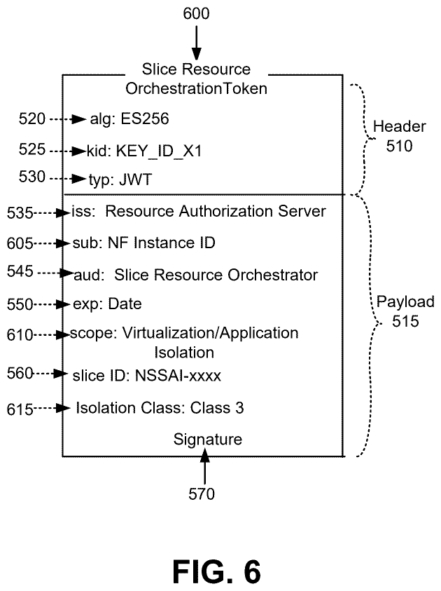

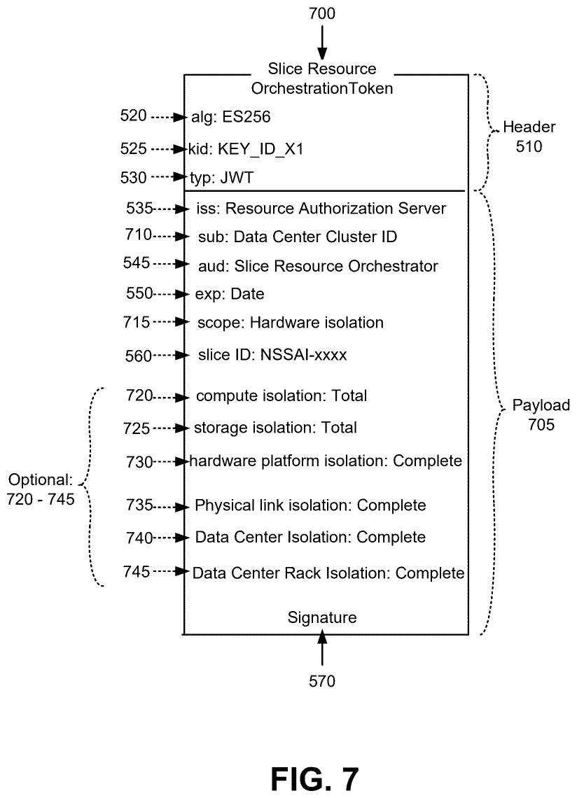

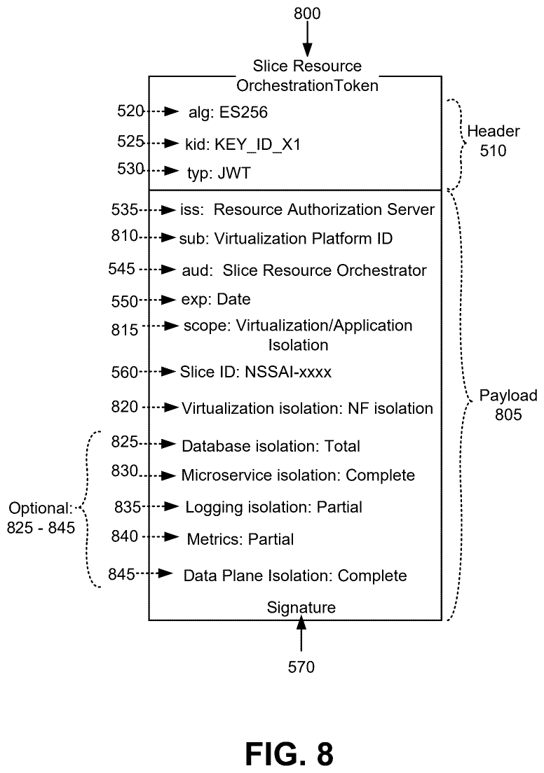

FIGS. 5-8 depict examples of Slice Resource Orchestration Tokens that may be used, as described further herein, to authorize one or more particular slice resources for a network slice, and to specify parameters associated with the particular slice resources, including, among other parameters, slice resource isolation. The tokens of FIGS. 5 and 6 depict examples in which each token specifies an isolation class to be applied to slice resources of a network slice. The tokens of FIGS. 7 and 8 depict examples in which each token specifies customized isolation levels to be applied to one or more specified slice resources. Though not shown in FIGS. 5-8, each of the tokens depicted may additionally include parameters associated with performance requirements (e.g., user/customer selected performance requirements) that respective network slices must satisfy, in addition to network slice resource isolation requirements.

As shown in the example of FIG. 5, token 500 includes a header 510 and a payload 515. Header 510 may include an algorithm (alg) field 520, a key identifier (kid) field 525, and a token typ (typ) field 530. Payload 515 may include an issuer (iss) field 535, a subject (sub) field 540, an audience (aud) field 545, an expiration (exp) field 550, a scope field 555, a Slice ID field 560, an isolation class field 565, and a signature field 570.

alg field 520 identifies a cryptographic algorithm used to generate the signature of field 570. In the example of FIG. 5, field 520 identifies the Elliptic Curve Digital Signature Algorithm 256(ES256) as the cryptographic algorithm used to generate the signature of field 570. kid field 525 contains a unique ID that identifies the cryptographic key/certificate used with the algorithm of field 520 to generate the signature of field 570. typ field 530 identifies a type of the token 500. In one implementation, the typ field 530 may identify a JavaScript Object Notation (JSON) Web Token (JWT) type.

iss field 535 identifies an entity that issued the token 500. In the example of FIG. 5, the issuer is identified as Resource Authorization Server 205. sub field 540 identifies a particular slice resource of the network slice, further identified by field 560, to which token 500 is directed. In the example of FIG. 5, the identified slice resource of the network slice is a particular Data Center cluster.

aud field 545 identifies one or more recipients of token 500 that are intended to process the token 500. The example of FIG. 5 identifies Slice Resource Orchestrator 210 as the recipient of token 500. exp field 550 identifies an expiration time and/or date, after which the token 500 should not be accepted for processing.

Scope field 555 identifies a scope of isolation to be applied to the slice resource of sub field 540. In some implementations, the scope of isolation may include either “hardware isolation” or “virtualization/application isolation.” Hardware isolation involves applying a level of isolation to one or more hardware resources in the network slice identified in slice ID field 560. Virtualization/application isolation involves applying a level of isolation to one or more virtualized or application resources in the network slice identified in slice ID field 560. In the example of FIG. 5, the slice resource identified in field 540 is a Data Center Cluster, and the scope identified in field 555 is hardware isolation to be applied to the Data Center Cluster.

Slice ID field 560 identifies a particular network slice to which token 500 applies. Slice ID field 560 may store, for example, a S-NSSAI value that uniquely identifies the network slice to which token 500 applies. Isolation class field 565 identifies a particular isolation class, from multiple isolation classes, that may be applied to the slice resources of the network slice identified by field 560 in accordance with the scope identified in field 555. The isolation class may include n isolation classes {class_1, class_2, . . . , class_n}, where n is equal to or greater than two. Each isolation class may specify a type and/or level of isolation to be applied to one or more types of slice resources in a network slice. As one example, a first isolation class_1 may apply hardware isolation that segregates both compute slice resources and storage slice resources of a network slice from other network slices. As another example, a second isolation class_1 may apply hardware isolation to only compute slice resources of a network slice, but permit the storage slice resources of the network slice to be shared among other network slices. Signature field 570 stores the digital signature, of the issuer identified in field 535, that has been generated using the cryptographic algorithm identified in field 520 with the cryptographic key/certificate identified in field 525.

In a second example of a token that specifies an isolation class to be applied to slice resources of a network slice, the Slice Resource Orchestration Token 600 of FIG. 6 includes some of the same fields 520-560 as described above with respect to FIG. 5, but includes fields 605, 610, and 615 that have different values than the example of FIG. 5. As shown in FIG. 6, sub field 605 identifies a NF Instance ID that corresponds to a particular NF within the network slice identified by slice ID field 560. Scope field 610 identifies that virtualization/application isolation is to be applied to the NF Instance identified in sub field 605 in accordance with the isolation class identified in field 615. The “Class 3” isolation class identified in field 615 may include a particular type and/or level of virtualization/application isolation to be applied to the NF Instance identified in sub field 605.

FIG. 7 depicts a first example of a slice resource orchestration token 700 in which the token 700 specifies customized isolation levels (e.g., customized by a customer/user associated with a network slice) to be applied to one or more specified slice resources. The token 700 specifies isolation levels to be applied to, for example, hardware slice resources (e.g., Data Center Cluster(s), Data Center, compute, storage, hardware platform, physical links, Data Center racks) within a network slice. The Slice Resource Orchestration Token 700 of FIG. 7 includes some of the same fields 520-560 and 570 as described above with respect to FIG. 5, but includes fields 710 and 715 that have different values than the examples of FIGS. 5 and 6 and also may include new optional fields 720-745 that specify customized isolation levels for particular hardware resources.

As shown in FIG. 7, sub field 710 identifies a particular data center cluster(s) to be used for implementing the network slice identified by the Slice ID field 560. The data center cluster may include a set of one or more interconnected data centers whose hardware, software, and/or virtualized resources are used to implement the network slice. Scope field 715 identifies that hardware isolation is to be applied to one or more hardware resources identified by sub field 710 in accordance with the customized isolation levels specified for particular hardware resources in fields 720-745.

Compute isolation field 720 identifies a level of isolation to be applied to compute resources of the data center cluster(s) identified in sub field 710. The compute resource isolation level may include, for example, no isolation, partial isolation, or total isolation. Storage isolation field 725 identifies a level of isolation to be applied to storage resources of the data center cluster(s) identified in sub field 710. The storage resource isolation level may include, for example, no isolation, partial isolation, or total isolation. Hardware platform isolation field 730 identifies a level of isolation to be applied to a hardware platform associated with the data center cluster (or other hardware) identified in sub field 710. The hardware platform isolation level may include, for example, no isolation, partial isolation, or complete isolation.

Physical Link isolation field 735 identifies a level of isolation to be applied to physical links to and/or from the data center cluster (or other hardware) identified in sub field 710. The physical link isolation level may include, for example, no isolation, partial isolation, or complete isolation. Data Center Isolation field 740 identifies a level of isolation to be applied to the one or more data centers of the data center cluster identified in sub field 710. The data center isolation level may include, for example, no isolation, partial isolation, or complete isolation. Data Center Rack Isolation field 745 identifies a level of isolation to be applied to one or more racks of the data centers of the data center cluster identified in sub field 710. The data center rack isolation level may include, for example, no isolation, partial isolation, or complete isolation.

FIG. 8 depicts a second example of a slice resource orchestration token 800 in which the token 800 specifies customized isolation levels to be applied to one or more specified slice resources. The token 800 specifies isolation levels to be applied to, for example, software, virtualized, and/or application slice resources (e.g., virtualization platforms, applications, databases, microservices, data plane) within a network slice. The Slice Resource Orchestration Token 800 of FIG. 8 includes some of the same fields 520-560 and 570 as described above with respect to FIG. 5, but includes fields 810 and 815 that have different values than the examples of FIGS. 5 and 6 and also may include optional fields 820-845 that specify customized isolation types and/or levels for particular virtualized or application resources.

As shown in FIG. 8, sub field 810 identifies a particular virtualization platform to be used for implementing the network slice identified by the Slice ID field 560. The virtualization platform may include a set of software, application, or other virtualized resources that are used to implement the network slice. Scope field 815 identifies that virtualization or application isolation is to be applied to the virtualization platform identified by sub field 710 in accordance with the customized isolation levels specified for particular virtualization, software, or application resources in fields 825-845.

Virtualization isolation field 820 identifies which type of software resource, virtualized resource, or application resource, associated with the virtualized platform identified in sub field 810 is to be isolated. The virtualization isolation type of field 820 may include, for example, NF isolation, microservice isolation, database isolation, or data plane isolation. Database isolation 825 identifies a level of isolation to be applied to databases used in the network slice identified in field 560. The database isolation level may include, for example, no isolation, partial isolation, or total isolation. Microservice isolation 830 identifies a level of isolation to be applied to microservices used in the network slice identified in field 560. The microservice isolation level may include, for example, no isolation, partial isolation, or complete isolation.

Logging isolation 835 identifies a level of isolation to be applied to logging events associated with the operation of the network slice identified in field 560. The logging isolation level may include, for example, no isolation, partial isolation, or total isolation. Metrics isolation 840 identifies a level of isolation to be applied to performance metrics that are measured with respect to resources used in the network slice identified by field 560. The metrics isolation level may include, for example, no isolation, partial isolation, or total isolation. Data plane isolation 845 identifies a level of isolation to be applied to data plane resources used by the network slice identified in field 560. The data plane isolation level may include, for example, no isolation, partial isolation, or total isolation.

FIGS. 5-8 depict examples of slice resource orchestration tokens for use in securely orchestrating network slice resources and for enforcing certain levels of network slice resource isolation, with the example tokens 500, 600, 700, and 800 having certain fields and values within those fields. However, the tokens used in the processes described herein may be configured differently than the examples shown in FIGS. 5-8, including additional or different fields that may have different values than those shown.

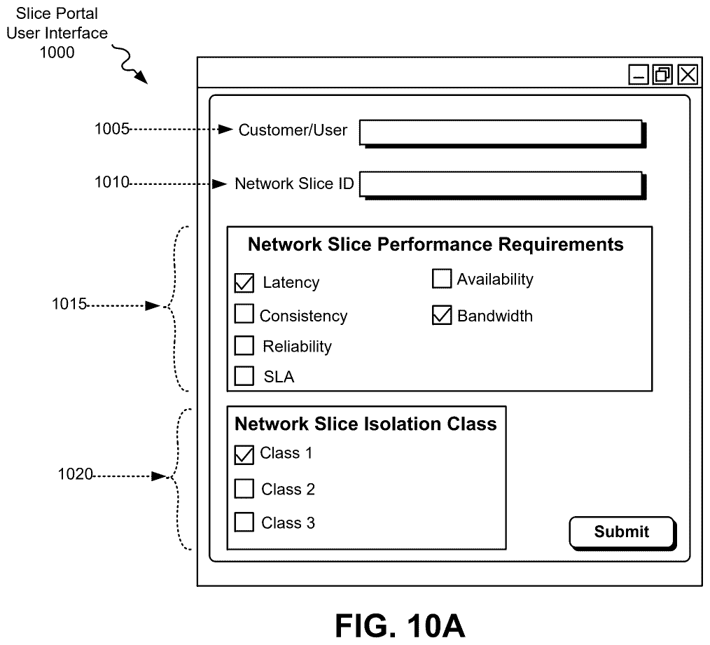

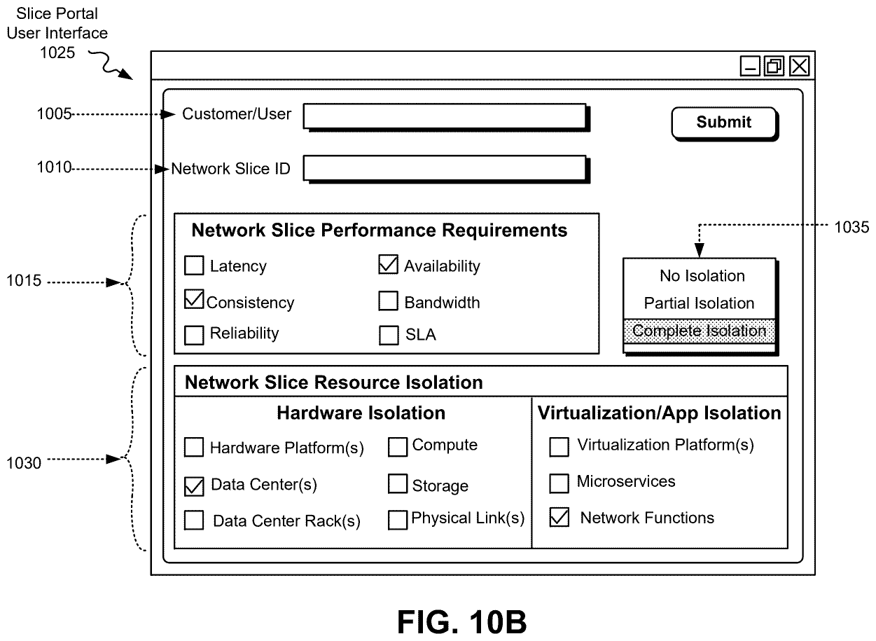

FIGS. 9A-9C are flow diagrams of an example process for orchestrating a network slice that satisfies slice performance requirements while also enforcing network slice isolation requirements. The process of FIGS. 9A-9C may be implemented by components of Slice Orchestration and Resource Isolation Enforcement System 135, in conjunction with Slice Portal 120. The process of FIGS. 9A-9C is described below with additional reference to FIGS. 10A, 10B, 11A, and 11B.

The example process includes a slice portal 120 receiving slice performance and slice resource isolation requirements for a customer/user requested network slice (block 900). In some circumstances, a customer's/user's chosen subscription service may specify the slice performance requirements and/or the slice resource isolation requirements, and these requirements may be transmitted directly to system 135 upon the customer's/user's enrollment in the subscription service. In other circumstances, the customer/user may use slice portal 120 to select and customize aspects of at least a portion of the network slice to which the customer/user is subscribing. In circumstances where a particular customer/user subscribes to a network slice to which other customers/users also subscribe, the slice resource isolation requirements may apply only to particular selected slice resources that are to be isolated (either entirely or partially) from slice resources used by other customers/users within the same network slice. For example, particular selected slice resources within the network slice may be dedicated to a particular customer's/user's use, while other customers/users using the same network slice use alternative slice resources). FIG. 10A depicts one example of a slice portal user interface 1000 that a customer/user may use (e.g., via a computer or smartphone) to supply user-selected slice performance requirements and/or user-selected slice resource isolation requirements. As shown, user interface 1000 may include a first field 1005 for entering a customer/user identifier (e.g., name, account number, etc.) and a second field 1010 for entering a network slice identifier (e.g., a user selected label) for the customer's/user's network slice. User Interface 1000 additionally includes a “Network Slice Performance Requirements” section 1015 that enables the customer/user to select and customize which performance requirements to apply to the customer's/user's network slice. By way of example, section 1015 shows latency, consistency, reliability, Service Level Agreement (SLA), availability, and bandwidth performance requirements. Though not shown in FIG. 10A, upon selection of a checkbox for a particular performance requirement, a drop-down box may further enable the customer/user to select a particular desired range, maximum, or minimum that is to be the slice's performance requirement (e.g., latency selected with a maximum of 25 milliseconds (ms), bandwidth selected with a minimum of 50 Megabits per second (Mbps)).

As further shown, user interface 1000 may include a “Network Slice Isolation Class” section 1020 that enables the customer/user to select a slice resource isolation class, from among multiple slice resource isolation classes, with each one of the multiple resource isolation classes having its own specified type(s) of resource isolation at a specified isolation level(s). Each resource isolation class may, therefore, represent a standardized set of one or more types of resource isolation to be applied to be applied to slice resources in the slice at a particular isolation level(s). For example, a “Class 1” may apply minimal, or no, resource isolation to slice resources in a slice, a “Class 2” may apply moderate resource isolation to a small set of slice resources in the slice, and a “Class 3” may apply maximum resource isolation to a large set of slice resources in the slice. The particular types and levels of resource isolation that each class may include can be designed by the network operator and offered to the customer/user for selection during network slice service subscription.

FIG. 10B depicts a second example of a slice portal user interface 1025 that a customer/user may use to select and customize slice performance requirements and/or slice resource isolation requirements. As shown, user interface 1025 may include fields 1005 and 1010 and “Network Slice Performance Requirements” section 1015 as already described with respect to FIG. 10A. User interface 1025 may further include a “Network Slice Resource Isolation” section 1030 that permits the customer/user to select one or more particular types of hardware isolation to be applied to the network slice and one or more particular types of virtualization or application isolation to be applied to the network slice.

As shown in FIG. 10B, some examples of the “hardware isolation” types that may be selected by the customer/user include hardware platform(s), data center(s), data center rack(s), compute, storage, and physical links. As further shown, some examples of the “Virtualization/application isolation” types that may be selected by the customer/user include virtualization platform(s), microservices, and network functions. Upon selection of a checkbox for a particular type of hardware isolation or virtualization/application isolation in section 1030, a drop-down box 1035 may appear on user interface 1025 enabling the customer/user to select a particular level of isolation, of multiple isolation levels, to be applied to the selected type of slice resource. The multiple levels of isolation may include, for example, no isolation, partial isolation, or complete or total isolation. Other types and/or levels of slice resource isolation, not shown in FIGS. 10A and 10B, may be available for selection via user interfaces 1000 or 1025. For example, user interfaces 1000 or 1025 may permit the customer/user to select a physical circuit(s), a virtual circuit(s), a physical network(s), and/or a virtual network(s) that are associated with a customer's/user's network slice for transport isolation and which extend from a gNB(s) 140 to one or more NFs, or other network elements, that service traffic of the network slice.

Upon completion of the selection/entering of the customer's/user's slice performance requirements and resource isolation requirements, slice portal 120 may generate a Slice Request message that includes details of the customer/user selected network slice performance requirements and the network slice resource isolation requirements and then sends the Slice Request message to Network Slice Orchestrator 200 via, for example, data network 115 and mobile network 110.

Network Slice Orchestrator 200 receives, from the slice portal 120, a Slice Request that includes the performance and resource isolation requirements (block 905), and determines resource parameters of the requested network slice based on the slice performance and slice resource isolation requirements (block 910). The determined resource parameters describe aspects of the slice resources that will be used to implement the requested network slice including, hardware, software, and virtualized resources and may also include configuration parameters for configuring the various hardware, software, and/or virtualized resources for the network slice. The resources described in the resource parameters for the network slice may include, for example, hardware platforms, data centers, data center racks, compute, storage, physical links, virtualization platforms, microservices, and NFs (or other applications). FIG. 11A depicts Slice Portal 120 sending a Slice Request message 1100 that includes the user-specified slice performance requirements and the user-specified slice resource isolation requirements to Network Slice Orchestrator 200, and Network Slice Orchestrator 200 using the contents of the message 1100 to determine 1105 network slice resource parameters for the requested network slice.

Network Slice Orchestrator 200 sends a resource authorization request to the Resource Authorization Server 205, including the determined slice resource parameters (block 915). Resource Authorization Server 205 generates signed tokens for each slice resource specified in the resource parameters and returns the signed tokens to the Network Slice Orchestrator 200 (block 920). Resource Authorization Server 205 generates a signature for each token using a cryptographic algorithm, as identified in field 520 of the token, and a cryptographic key as further identified in field 525 of the token. The cryptographic key may, for example, a private cryptographic key shared with Resource Authorization Server 205, or obtained from a centralized key repository. Resource Authorization Server 205 populates the fields of each token with values that are appropriate for each slice resource that is to be orchestrated, and inserts the generated signature within each token prior to returning the signed tokens to Network Slice Orchestrator 200. FIG. 11A illustrates an example of Network Slice Orchestrator 200 sending a Resource Authorization Request 1110 to RAS 205, and RAS 205 generating 1115 a signed Slice Resource Orchestration Token for each slice resource to be used in implementing the requested network slice. FIG. 11A further shows RAS 205 returning a message 1120 that includes the signed Slice Resource Orchestration Tokens to Network Slice Orchestrator 200.

Network Slice Orchestrator 200 sends a request for resource orchestration to the Slice Resource Orchestrator, including the signed slice resource orchestration tokens (block 925). Upon receipt of the request, Slice Resource Orchestrator 210 validates the slice resource tokens and extracts HW orchestration tokens for hardware slice resources from the slice resource tokens (block 930). Slice Resource Orchestrator 210 uses each token's identified cryptographic algorithm and identified public key to validate the respective token. Slice Resource Orchestrator 210 extracts the slice resource tokens having a hardware resource identified in sub field 540 and/or hardware isolation identified in scope field 555 and identifies the extracted tokens as the HW orchestration tokens to be used for orchestrating hardware slice resources for the network slice. FIG. 11A shows Network Slice Orchestrator 200 sending a Resource Orchestration Request 1125 to Slice Resource Orchestrator 210 that includes the signed slice resource orchestration tokens. FIG. 11A further shows Slice Resource Orchestrator 210 validating 1130 the received slice resource orchestration tokens 1130 and extracting 1135 the HW orchestration tokens from the batch of slice resource orchestration tokens received in the Resource Orchestration Request 1125.

Slice Resource Orchestrator 210 sends a Hardware Request to the HW Resource Orchestrator that includes the HW orchestration tokens (block 935) (FIG. 9B), HW Resource Orchestrator 215 validates the HW orchestration tokens (940), orchestrates the hardware resources for the network slice and generates a report of the orchestrated hardware resources (block 945), and returns the report of the orchestrated hardware resources to the Slice Resource Orchestrator 210 (block 950). HW Resource Orchestrator 215 uses each HW orchestration token's identified cryptographic algorithm and identified public key to validate the respective token. HW Resource Orchestrator 215 orchestrates the hardware resources in accordance with the payload values of each respective HW orchestration token. Orchestration of the slice hardware resources may include allocating, provisioning, and/or configuring the hardware resources specified in the orchestration tokens to meet the performance requirements of the network slice and to satisfy the hardware isolation requirements of the network slice.

As one example, referring to the token 500 of FIG. 5, HW Resource Orchestrator 215 extracts the values from fields 540, 555, 560, and 565 and uses those values to orchestrate the hardware resources of a cluster of data centers, in accordance with the resource isolation identified in field 565, for the network slice identified in field 560. As another example, referring to the token 700 of FIG. 7, HW Resource Orchestrator 215 extracts the values from fields 710, 715, and 560, and 720-745 (if present), uses those values to orchestrate a cluster of data centers, in accordance with the resource isolation identified in field 565, for the network slice identified in field 560. The report generated by HW Resource Orchestrator 215 details the hardware resources, and their level(s) of isolation and configuration, that have been orchestrated to serve the network slice. FIG. 11A depicts Slice Resource Orchestrator 210 sending a HW Request 1140 to HW Resource Orchestrator 215 that includes the HW orchestration tokens. FIG. 11B further depicts HW Resource Orchestrator 215 validating 1145 the HW orchestration tokens, orchestrating 1150 the HW resources, generating 1155 a report of the orchestrated HW resources, and returning the generated Report 1160 to Slice Resource Orchestrator 210, where the Report 1160 includes details of the orchestrated HW resources.

Slice Resource Orchestrator 210 extracts orchestration tokens for the virtualization/application resources from the slice resource orchestration tokens (block 955), and sends a Virtualization/Application Request to Application Orchestrator 220 that includes the virtualization/application resource orchestration tokens and the report of the orchestrated hardware resources (block 960). Slice Resource Orchestrator 210 extracts the slice resource tokens (e.g., received in block 925 from Network Slice Orchestrator 200) having a virtualized or application resource identified in sub field 605 or 810 and/or a virtualization isolation identified in scope field 610 or 820 and identifies the extracted tokens as the Virtualization/application orchestration tokens to be used for orchestrating virtualized/application slice resources for the network slice. FIG. 11B illustrates Slice Resource Orchestrator 210 extracting 1165 virtualization/app resource tokens from the slice resource orchestration tokens, and sending a Virtualization/App Request 1170 to App orchestrator 220 that includes the Virtualization/App tokens and the orchestrated HW resource report.

Application orchestrator 215 validates the virtualization/application orchestration tokens (block 965), orchestrates the virtualization/application resources for the network slice and generates a report of the orchestrated virtualization/application resources (block 970) (FIG. 9C), and returns the report of the orchestrated virtualization/application resources to the Slice Resource Orchestrator 210 (block 975). Application Orchestrator 220 uses each virtualization/application orchestration token's identified cryptographic algorithm and identified private key to validate the respective token. Application Orchestrator 220 orchestrates the virtualized and application resources in accordance with the payload values of each respective virtualization/application orchestration token. Orchestration of the slice virtualized/application resources may include instantiating, allocating, provisioning, and/or configuring the virtualized/application resources specified in the orchestration tokens, using the previously orchestrated hardware resources that have been identified in the hardware resource orchestration report, to meet the performance requirements of the network slice and to satisfy the virtualization/application isolation requirements of the network slice.

As one example, referring to the token 600 of FIG. 6, Application Orchestrator 220 extracts the values from fields 605, 610, 560, and 615 and uses those values to orchestrate a NF Instance, in accordance with the resource isolation identified in field 615, for the network slice identified in field 560. As another example, referring to the token 800 of FIG. 8, Application Resource Orchestrator 220 extracts the values from fields 810, 815, 560, 820, and fields 825-845 (if present), and uses those values to orchestrate a virtualization platform in accordance with the resource isolation identified in field 820, and any of fields 825-845 that are present in token 800, for the network slice identified in field 560. The report generated by Application Orchestrator 220 details the virtualized and application resources, and their levels(s) of isolation and configuration, that have been orchestrated to serve the network slice. FIG. 11B further illustrates App Orchestrator 220 validating 1175 the virtualization/app orchestration tokens, orchestrating 1180 the virtualization/app resources on to the hardware resources (i.e., hardware resources identified within the report generated by HW Resource Orchestrator 215), generating 1185 a report of the orchestrated virtualization/app resources, and returning the Report 1190 to Slice Resource Orchestrator 210 that includes details of the orchestrated virtualization/app resources.

Slice Resource Orchestrator 210, in turn, returns the received reports of the orchestrated hardware resources and the orchestrated virtualization/application resources to the Network Slice Orchestrator 200 (block 980). Network Slice Orchestrator 200 may store the contents of the reports as the parameters of the orchestrated network slice for future inspection and reference. Network Slice Orchestrator 200 may also send a notification, to a particular customer/user 130 via, for example, slice portal 120 that indicates that orchestration of the customer's/user's requested network slice has been completed, and the notification may further include selected content from the reports of the orchestrated hardware resources and the orchestrated virtualization/application resources. FIG. 11B illustrates Slice Resource Orchestrator 210 returning a message 1195 that includes both the Orchestrated HW resources report and the orchestrated virtualization/app resources report. The reports generated by the HW Resource Orchestrator 215 and the Application Orchestrator 220 may also be digitally signed by them using their respective private keys. Therefore, a consumer of each report may be able to validate the authenticity and integrity of each report by validating the digital signature using a respective public key/certificate associated with HW Resource Orchestrator 215 or Application Orchestrator 220.

The foregoing description of implementations provides illustration and description, but is not intended to be exhaustive or to limit the invention to the precise form disclosed. Modifications and variations are possible in light of the above teachings or may be acquired from practice of the invention. For example, while a series of blocks has been described with respect to FIGS. 9A-9C , and sequences of operations, messages, and/or data flows with respect to FIGS. 11A and 11B, the order of the blocks and/or the operations, messages, and/or data flows may be varied in other implementations. Moreover, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processing unit 420) of a device. A non-transitory storage medium includes one or more of the storage mediums described in relation to memory 430. The non-transitory computer-readable storage medium may be implemented in a centralized, distributed, or logical division that may include a single physical memory device or multiple physical memory devices spread across one or multiple network devices.

To the extent the aforementioned embodiments collect, store or employ personal information of individuals, such information shall be collected, stored, and used in accordance with all applicable laws concerning protection of personal information. Additionally, the collection, storage and use of such information can be subject to consent of the individual to such activity, for example, through well known “opt-in” or “opt-out” processes as can be appropriate for the situation and type of information. Collection, storage and use of personal information can be in an appropriately secure manner reflective of the type of information, for example, through various encryption and anonymization techniques for particularly sensitive information.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

All structural and functional equivalents to the elements of the various aspects set forth in this disclosure that are known or later come to be known to those of ordinary skill in the art are expressly incorporated herein by reference and are intended to be encompassed by the claims.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a network device, user-selected performance requirements for a network slice to be implemented in a network;
receiving, by the network device, user-selected resource isolation requirements for the network slice, wherein the user selected resource isolation requirements specify a level of isolation to be applied to resources of the network slice in the network; and
initiating, by the network device, orchestration of the resources of the network slice such that the network slice satisfies the user-selected performance requirements and the resources of the network slice comply with the user-selected resource isolation requirements.

2. The method of claim 1, wherein the user-selected resource isolation requirements specify at least one slice resource of the network slice, among multiple slice resources, to be isolated relative to different users of the network slice.

3. The method of claim 1, wherein the user selected resource isolation requirements specify a slice resource of the network slice, among multiple slice resources, to be isolated from other network slices.

4. The method of claim 1, wherein the user selected resource isolation requirements specify at least one of hardware isolation or virtualization/application isolation to be applied to hardware, application, or virtualized resources of the network slice relative to the other network slices.

5. The method of claim 1, wherein the user selected resource isolation requirements specify at least one of hardware platform, data center, data center rack, compute, storage, physical link, physical circuit, or physical network isolation to be applied to the resources of the network slice relative to the other network slices.

6. The method of claim 1, wherein the user selected resource isolation requirements specify at least one of virtualization platform, microservices, network functions, virtual circuit, or virtual network isolation to be applied to the resources of the network slice relative to the other network slices.

7. The method of claim 1, wherein initiating the orchestration further comprises:
determining, by the network device, resource parameters of the network slice based on the user selected performance requirements and the user selected resource isolation requirements; and
sending a resource authorization request to a Resource Authorization Server (RAS) that includes the determined resource parameters.

8. The method of claim 7, wherein initiating the orchestration further comprises:
receiving, from the RAS, one or more slice resource orchestration tokens, each having digital signatures;
validating each of the digital signatures; and
sending, by the network device to a Slice Resource Orchestrator, a Request for Resource Orchestration that includes the one or more slice resource orchestration tokens.

9. A network device, comprising:
at least one communication interface configured to communicate via a network; and
at least one processor configured to:
receive user-selected performance requirements for a network slice to be implemented in a network,
receive user-selected resource isolation requirements for the network slice, wherein the user selected resource isolation requirements specify a level of isolation to be applied to resources of the network slice in the network, and
initiate, via the at least one communication interface, orchestration of the resources of the network slice such that the network slice satisfies the user-selected performance requirements and the resources of the network slice comply with the user-selected resource isolation requirements.

10. The device of claim 9, wherein the user selected resource isolation requirements specify a slice resource of the network slice, among multiple slice resources, to be isolated from other network slices, or
wherein the user-selected resource isolation requirements specify at least one slice resource of the network slice, among multiple slice resources, to be isolated relative to different users of the network slice.

11. The device of claim 9, wherein the user selected resource isolation requirements specify at least one of hardware isolation or virtualization/application isolation to be applied to hardware, application, or virtualized resources of the network slice relative to the other network slices.

12. The device of claim 9, wherein the user selected resource isolation requirements specify at least one of hardware platform, data center, data center rack, compute, storage, physical link, physical circuit, or physical network isolation to be applied to the resources of the network slice relative to the other network slices.

13. The device of claim 9, wherein the user selected resource isolation requirements specify at least one of virtualization platform, microservices, network functions, virtual circuit, or virtual network isolation to be applied to the resources of the network slice relative to the other network slices.

14. The device of claim 9, wherein, when initiating the orchestration, the at least one processor is further configured to:
determine resource parameters of the network slice based on the user selected performance requirements and the user selected resource isolation requirements, and
send, via the at least one communication interface, a resource authorization request to a Resource Authorization Server (RAS) that includes the determined resource parameters.

15. The device of claim 14, wherein, when initiating the orchestration, the at least one processor is further configured to:
receive, from the RAS via the at least one communication interface, one or more slice resource orchestration tokens, each having digital signatures;
validate each of the digital signatures; and
send, via the at least one communication interface to a Slice Resource Orchestrator, a Request for Resource Orchestration that includes the one or more slice resource orchestration tokens.

16. A non-transitory storage medium storing instructions executable by a network device, wherein the instructions cause the network device to:
receive user-selected performance requirements for a network slice to be implemented in a network;
receive user-selected resource isolation requirements for the network slice, wherein the user selected resource isolation requirements specify a level of isolation to be applied to resources of the network slice in the network; and
initiate orchestration of the resources of the network slice such that the network slice satisfies the user-selected performance requirements and the resources of the network slice comply with the user-selected resource isolation requirements.

17. The non-transitory storage medium of claim 16, wherein the user selected resource isolation requirements specify a slice resource of the network slice, among multiple slice resources, to be isolated from other network slices, or
wherein the user-selected resource isolation requirements specify at least one slice resource of the network slice, among multiple slice resources, to be isolated relative to different users of the network slice.

18. The non-transitory storage medium of claim 16, wherein the user selected resource isolation requirements specify at least one of hardware isolation or virtualization/application isolation to be applied to hardware, application, or virtualized resources of the network slice relative to the other network slices.

19. The non-transitory storage medium of claim 16, wherein the user selected resource isolation requirements specify at least one of hardware platform, data center, data center rack, compute, storage, physical link, physical circuit, or physical network isolation to be applied to the resources of the network slice relative to the other network slices, or
wherein the user selected resource isolation requirements specify at least one of virtualization platform, microservices, network functions, virtual circuit, or virtual network isolation to be applied to the resources of the network slice relative to the other network slices.

20. The non-transitory storage medium of claim 16, wherein the instructions to cause the network device to initiate the orchestration further comprise instructions to cause the network device to:
determine resource parameters of the network slice based on the user selected performance requirements and the user selected resource isolation requirements;
send a resource authorization request to a Resource Authorization Server (RAS) that includes the determined resource parameters;
receive, from the RAS, one or more slice resource orchestration tokens, each having digital signatures;
validate each of the digital signatures; and
send, to a Slice Resource Orchestrator, a Request for Resource Orchestration that includes the one or more slice resource orchestration tokens.
